(19) United States
(12) Patent Application Publication
(10) Pub. No.: US 2018/0036721 A1
(43) Pub. Date: Feb. 8, 2018

(54) METHOD FOR MANUFACTURING PHOTOSEMICONDUCTOR, PHOTOSEMICONDUCTOR AND HYDROGEN PRODUCTION DEVICE

(71) Applicant: Panasonic Corporation, Osaka (JP)

(72) Inventors: HIDEAKI MURASE, Osaka (JP); KAZUHITO HATO, Osaka (JP)

(21) Appl. No.: 15/646,653

(22) Filed: Jul. 11, 2017

(30) Foreign Application Priority Data
Aug. 8, 2016 (JP) 2016-155734

(51) Int. Cl. B01J 27/24; H01G 9/00; C01B 3/04; B01J 35/00; B01J 37/02; B01J 37/34; H01G 9/20; B01J 19/12

(52) U.S. Cl. CPC B01J 27/24; H01G 9/20; H01G 9/0029; B01J 19/127; B01J 35/0006; B01J 35/004; B01J 37/0244; B01J 37/347; B01J 37/349; C01B 3/042; B01J 2219/1203; B01J 2219/0892; B01J 2219/0877

(57) ABSTRACT

A method for manufacturing a photosemiconductor according to the present disclosure includes: forming an oxide on a base material, the oxide containing at least one kind of transition metal; and preparing a photosemiconductor containing the transition metal and a nitrogen element from the oxide by subjecting the oxide to a treatment with a plasma of a nitrogen-containing gas which is generated at a frequency in a VHF range under a pressure lower than atmospheric pressure.

### BACKGROUND

### 1. Technical Field

The present disclosures relates to a method for manufacturing a photosemiconductor, a photosemiconductor and a hydrogen production device.

### 2. Description of the Related Art

When a photosemiconductor is irradiated with light, electron-hole pairs are generated in the photosemiconductor. Photosemiconductors can be applied to uses such as light emitting diodes (LEDs) and lasers which extract light generated in recombination of the electron-hole pairs; solar cells which spatially separate the pairs to extract photovoltaic power as electric energy; and photocatalysts which produce hydrogen directly from water and sunlight. Thus, photosemiconductors are promising. A group of photosemiconductors that absorb or release light in an ultraviolet-to-visible light range include oxides, oxynitrides and nitrides. Particularly, as photosemiconductors for use in photocatalysts, typically titanium oxide (TiO₂), zinc oxide (ZnO) and gallium nitride (GaN) have been used. A conventional semiconductor electrode including such a photosemiconductor has a problem of low hydrogen generation efficiency in water splitting reaction by irradiation of sunlight. This is because a semiconductor material such as TiO₂ can absorb only light having a short wavelength, generally a wavelength of not more than 400 nm, and in the case of TiO₂, a ratio of utilizable light to total sunlight is very low, i.e. about 4.7%. Further, considering a loss from a theoretical thermal loss, utilization efficiency of the sunlight is about 1.7% with respect to the absorbed light.

Thus, a photosemiconductor material capable of increasing a ratio of utilizable light to total sunlight, i.e. a photosemiconductor material capable of absorbing light in a visible light range, which has a longer wavelength, in order to improve hydrogen generation efficiency in water splitting reaction by irradiation of sunlight, is desired.

In response to this demand, a photosemiconductor material intended to improve utilization efficiency of sunlight by absorbing visible light having a longer wavelength has been suggested. For example, PTL 1 discloses a photocatalyst composed of a niobium oxynitride represented by compositional formula: NbON, as a semiconductor material capable of absorbing visible light. According to PTL 1, the niobium oxynitride is capable of absorbing light having a wavelength of not more than 560 nm. This indicates that the niobium oxynitride is a material in which the ratio of utilizable light to total sunlight is 28%, and when a thermal loss is considered, a sunlight energy conversion efficiency of up to 13% can be attained.

### CITATION LIST

### Patent Literature

PTL 1: Japanese Patent No. 5165155

### Non-Patent Literatures

NPL 1: Moussab Harb et. al., “Tuning the properties of visible-light-responsive tantalum (oxy)nitride photocatalysts by nonstoichiometric compositions: a first-principles viewpoint” Physical Chemistry Chemical Physics, 2014, Volume 16, Issue 38, 20548-29569

NPL 2: Roger Marchand et. al., “Nitrides and oxynitrides: Preparation, crystal chemistry and properties”, Journal of the European Ceramic Society, Volume 8, Issue 4 (1991), Pages 197-213

NPL 3: Francis J DiSalvo et. al. “Ternary nitrides: a rapidly growing class of new materials” Current Opinion in Solid State & Materials Science 1996, 1, 241-249

For increasing a ratio of utilizable light to total sunlight in order to improve hydrogen generation efficiency in water splitting reaction as described above, use of an oxynitride or nitride photosemiconductor is one solution. Specifically, a valence band in the oxynitride or nitride photosemiconductor is constituted by an N2p orbit level, and the N2p orbit level is closer to an oxidized level of water than to an O2p orbit. In other words, the valence band in the oxynitride or nitride photosemiconductor is positioned at a higher energy level as compared to a valence band constituted by an O2p orbit in an oxide photosemiconductor. Thus, the oxynitride or nitride photosemiconductor is capable of narrowing a width of a band gap, i.e. widening a wavelength range over which a reaction with light takes place, so that a photocurrent value can be increased.

The oxynitride or nitride photosemiconductor is manufactured by use of, for example, a metal oxide as a starting material. As a conventional method for manufacturing an oxynitride or nitride by use of a metal oxide as a starting material, a reduction nitriding synthesis reaction using an ammonia gas is generally employed (NPL 1).

However, the conventional method for manufacturing an oxynitride or nitride from a metal oxide by a reduction nitriding synthesis reaction using an ammonia gas has a problem in complexity, throughput and safety.

### SUMMARY

One non-limiting and exemplary embodiment provides a method for manufacturing a photosemiconductor, the method being capable of manufacturing a photosemiconductor containing a transition metal and a nitrogen element more safely and conveniently with a higher throughput as compared to a conventional manufacturing method.

In one general aspect, the techniques disclosed here feature a method for manufacturing a photosemiconductor, the method including treating an oxide containing at least one transition metal with a plasma under a pressure lower than atmospheric pressure to provide the photosemiconductor containing the transition metal and a nitrogen element from the oxide,

wherein

the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

With the manufacturing method of the present disclosure, a photosemiconductor containing a transition metal and a nitrogen element can be manufactured safely and conveniently with a high throughput.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

It should be noted that general or specific embodiments may be implemented as a system, a method, an integrated circuit, a computer program, a storage medium, or any selective combination thereof.

### BRIEF DESCRIPTION OF THE DRAWINGS

FIG. 1 is a schematic view showing an example of a configuration of a plasma generating apparatus to be used in a method for manufacturing a photosemiconductor according to one exemplary embodiment of the present disclosure;

FIG. 2 is a sectional view showing a starting material layer before plasma treatment, which is obtained in one example of a step in the method for manufacturing a photosemiconductor according to one exemplary embodiment of the present disclosure;

FIG. 3 is a sectional view showing a photosemiconductor layer after plasma treatment, which is obtained in one example of a step in the method for manufacturing a photosemiconductor according to one exemplary embodiment of the present disclosure;

FIG. 4 is a schematic view showing one example of a configuration of a hydrogen production device according to one exemplary embodiment of the present disclosure;

FIG. 5 shows results of X-ray diffraction for a starting material layer before plasma treatment and a photosemiconductor layer after plasma treatment, each of which is obtained in Example 1 of the present disclosure;

FIG. 6 shows results of visible ultraviolet absorption spectroscopy for the starting material layer before plasma treatment and the photosemiconductor layer after plasma treatment, each of which is obtained in Example 1 of the present disclosure;

FIG. 7 shows results of X-ray diffraction for a starting material layer before plasma treatment and a photosemiconductor layer after plasma treatment, each of which is obtained in Example 2 of the present disclosure;

FIG. 8 shows results of visible ultraviolet absorption spectroscopy for the starting material layer before plasma treatment and the photosemiconductor layer after plasma treatment, each of which is obtained in Example 2 of the present disclosure;

FIG. 9 shows results of visible ultraviolet absorption spectroscopy for a starting material layer before plasma treatment and a photosemiconductor layer after plasma treatment, each of which is obtained in Example 3 of the present disclosure;

FIG. 10 shows results of X-ray diffraction for a starting material layer before plasma treatment and a photosemiconductor layer after plasma treatment, each of which is obtained in Example 4 of the present disclosure; and

FIG. 11 shows results of visible ultraviolet absorption spectroscopy for the starting material layer before plasma treatment and the photosemiconductor layer after plasma treatment, each of which is obtained in Example 4 of the present disclosure.

### DETAILED DESCRIPTION

<Circumstances Leading to Attainment of One Aspect According to the Present Disclosure>

A photosemiconductor capable of improving hydrogen generation efficiency in water splitting reaction, and increasing a ratio of utilizable light to total sunlight may be an oxynitride or nitride photosemiconductor. Specifically, a valence band in the oxynitride or nitride photosemiconductor is constituted by an N2p orbit level, and the N2p orbit level is closer to an oxidized level of water than to an O2p orbit. In other words, the valence band in the oxynitride or nitride photosemiconductor is positioned at a higher energy level as compared to a valence band constituted by an O2p orbit in an oxide photosemiconductor. Thus, the oxynitride or nitride photosemiconductor is capable of narrowing a width of a band gap, i.e. widening a wavelength range over which a reaction with light takes place, so that a photocurrent value can be increased.

The oxynitride or nitride photosemiconductor is manufactured by use of, for example, a metal oxide as a starting material. As a conventional method for manufacturing an oxynitride or nitride by use of a metal oxide as a starting material, a reduction nitriding synthesis reaction using an ammonia gas is generally employed (NPL 1). In the reduction nitriding synthesis reaction, ammonia is supplied to a metal oxide as a starting material at a high temperature, and nitrogen replaces oxygen in the metal oxide, so that the reaction proceeds. This reaction is generally called an ammonia gas reduction nitriding method, or an ammonolysis reaction. For example, a reaction formula for synthesis of a nitride (Ta₃N₅) of pentavalent tantalum is as shown in formula (A) below.

3Ta₂O₅+10NH₃→2Ta₃N₅+15H₂O↑ (A)

Specifically, when a metal oxide is used, a reaction process in the ammonia gas reduction nitriding method represented by formula (A) involves a reduction reaction in which hydrogen in active species such as NH₂ and NH generated by thermal decomposition in the reaction process reacts with oxygen in the metal oxide to be desorbed as water vapor, and a nitriding reaction in which nitrogen atoms are introduced in the metal oxide. However, formula (A) represents merely an ideal reaction, and in a real reaction process, a competitive reaction as shown below takes place, so that reaction efficiency is inevitably reduced.

NH₃→1/2N₂+3/2H₂ (B)

2Ta₃N₅+15H₂O→3Ta₂O₅+10NH₃ (C)

Specifically, the reaction may be described as follows. As shown in formula (B), generally ammonia (NH₃) is thermally decomposed into nitrogen (N₂) and hydrogen (H₂) at 500° C. A nitrogen molecule forms a triple bond, and binding energy of the triple bond is 941 kJ/mol, which is much larger than, for example, binding energy (500 kJ/mol) of an oxygen molecule that forms a double bond. In other words, the nitrogen molecule is very stable, high activation energy is therefore required for a direct reaction between nitrogen and a metal oxide, and the reaction is normally difficult to proceed under an equilibrium condition. NPL 2 suggests that the reduction nitriding reaction of a gaseous mixture of nitrogen and hydrogen prevents a reaction from efficiently proceeding. NPL 3 suggests that free energy of formation of an oxide is relatively stable in comparison with free energy of formation of a nitride, and under a high temperature at which an ammonia gas reduction nitriding method is applied, an oxidation reaction with water vapor secondarily produced as in formula (C) proceeds again, so that reaction efficiency is reduced.

In a normal ammonia gas reduction nitriding method, secondarily produced water vapor is quickly removed, and a large amount of an ammonia gas is supplied for promoting a reaction at a surface of a metal oxide (starting material) in order to avoid reduction of reaction efficiency as described above. Specifically, generally retention time r of a gas in a chamber satisfies a relationship of τ=PV/Q (P: pressure, V: chamber volume, Q: gas flow rate), and therefore when a large amount of an ammonia gas is fed, the retention time of all gases including water vapor decreases, so that fresh ammonia that is not thermally decomposed is supplied to a thin film surface to improve reaction efficiency. However, since the reaction requires a long time, a large amount of ammonia is required to be continuously supplied during the reaction, and installation of a damage elimination apparatus, etc. is thus absolutely necessary, so that the reaction system is very complicated, and has very poor economic efficiency. Ammonia is a Group-3 specified chemical substance, and has a problem in safety in mass production. As described above, a temperature in synthesis is relatively high, i.e. not lower than a thermal decomposition temperature (500° C.) of ammonia, leading to a temporal constraint in a temperature rising and falling process. Specifically, for example, a treatment time of at least about 12 hours in total is required. As a result, there is a problem in throughput.

With regard to a method for manufacturing a photosemiconductor containing nitrogen, such as a nitride or an oxynitride, the inventors of the present disclosure have found the above-mentioned problems, and extensively conducted studies. Resultantly, the inventors of the present disclosure have attained a manufacturing method capable of manufacturing an oxynitride or a nitride safely and conveniently with a high throughput under a low-temperature condition by subjecting an oxidant as a starting material to a treatment using a plasma of a nitrogen-containing gas. The manufacturing method has an aspect as shown below.

<Outline of One Aspect According to the Present Disclosure>

A method for manufacturing a photosemiconductor according to a first aspect of the present disclosure includes treating an oxide containing at least one transition metal with a plasma under a pressure lower than atmospheric pressure to provide the photosemiconductor containing the transition metal and a nitrogen element from the oxide,

wherein

the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

In the method for manufacturing a photosemiconductor according to the first aspect, a photosemiconductor containing a transition metal and a nitrogen element is prepared from the oxide by subjecting the oxide to a treatment with a plasma of a nitrogen-containing gas which is generated at a frequency in a VHF range (i.e. not less than 30 MHz and not more than 300 MHz) under a pressure lower than atmospheric pressure. By using a plasma generated at a frequency in a VHF range as described above, a plasma density in the plasma treatment can be increased, i.e. chemically very active radical ion species (excited species) can be grown. Specifically, the plasma density increases in proportion to a square of a power frequency when a pressure and a volume are constant. A chemical reaction rate increases as a number of particles that collide per unit time becomes larger. In other words, as a concentration of substances that contribute to the reaction increases, a collision probability of reactants becomes higher, and therefore the chemical reaction rate increases. Thus, an increase in plasma density makes it possible to increase a chemical reaction rate at which an oxide as a starting material is nitrided. Here, the plasma density refers to an ion density and electron density at which positively charged ions, negatively charged electrons and neutral particles existing in a plasma reach an equilibrium state after being repeatedly excited, ionized and recombined.

When a plasma generated at a frequency in a VHF range is used, kinetic energy of charged particles decreases because a collision frequency of atoms and molecules in the plasma is high, and further, a difference between a plasma potential and a base material surface potential, i.e. a sheath potential decreases, so that a self bias voltage can be reduced. Accordingly, influences of ion impact can be suppressed, so that deterioration of quality of a surface of a photosemiconductor, i.e. generation of defects can be suppressed. Here, the self bias voltage is as follows. In a plasma generated by use of a high frequency, a high-frequency current is fed through an electrode to change a direction of an electric field in a very short period. At this time, ions existing in the plasma and having a relatively large mass cannot follow the electric field change, while electrons in the plasma follow an external electric field to reach the electrode at a high speed, and are negatively charged. As a result, a direct-current negative bias voltage, i.e. a self bias voltage is generated near the electrode. By an electric field resulting from a self bias of the electrode, ions are accelerated to collide against the electrode having a negative bias potential, and give ion impact. This is one of factors of generating defects.

The gas is any one of the items (i) to (iv). Since the gas does not contain hydrogen, ammonia is not generated. Accordingly, the reaction of formula (B) does not take place, and therefore reduction of reaction efficiency can be avoided. Further, since the gas does not contain water, the reaction of (C) does not take place. Thus, reduction of reaction efficiency can be avoided. The gas may contain oxygen as shown in items (ii) to (iv). Oxygen stabilized an oxynitride obtained by a reaction of an oxide and nitrogen. As one example, a niobium oxide represented by chemical formula Nb₂O₅ is nitrided by nitrogen represented by chemical formula N₂ to obtain a niobium oxynitride represented by chemical formula NbON. Niobium contained in the niobium oxynitride represented by chemical formula NbON is pentavalent. The niobium oxynitride represented by chemical formula NbON can be further nitrided by nitrogen to change into niobium nitride represented by chemical formula NbN. Niobium contained in niobium nitride represented by chemical formula NbN is trivalent. Oxygen serves to ensure that niobium contained in a niobium compound is kept pentavalent. In other words, oxygen inhibits the niobium oxynitride from being further nitrided under a nitrogen atmosphere.

As described above, with the method for manufacturing a photosemiconductor according to the first aspect, a photosemiconductor can be manufactured in a shorter time as compared to a conventional manufacturing method using an ammonia gas reduction nitriding method, and as a result, the throughput can be improved. In the method for manufacturing a photosemiconductor according to the first aspect, safety is secured because use of an ammonia gas is not essential, and convenience is improved because installation of a damage elimination apparatus etc., is not required. In the method for manufacturing a photosemiconductor according to the first aspect, costs for manufacturing of a photosemiconductor can be reduced due to improvement of the throughput and convenience, etc. The photosemiconductor obtained by the manufacturing method according to the first aspect contains at least a nitrogen element and at least one transition metal in a crystal structure. Accordingly, a photosemiconductor capable of widening a wavelength range over which a reaction with light takes place can be obtained. Specifically, the valence band in an oxynitride or nitride photosemiconductor is positioned at a higher level as compared to the valence band in an oxide photosemiconductor, and therefore it is possible to narrow the width of the band gap, i.e. widen a wavelength range over which a reaction with light takes place, so that the photocurrent value can be increased.

In a second aspect, for example, the photosemiconductor may be a visible light-responsive photocatalyst in the manufacturing method according to the first aspect.

With the manufacturing method according to the second aspect, photosemiconductor serving as a visible light-responsive photocatalyst can be manufactured safely and conveniently with a high throughput.

In a third aspect, for example, the gas may be any one of (ii) a gaseous mixture of a nitrogen gas and an oxygen gas and (iv) a gaseous mixture of a nitrogen gas, an oxygen gas and a rare gas, the oxygen gas having a partial pressure of not more than 0.1%, in the manufacturing method according to the first or second aspect.

With the manufacturing method according to the third aspect, a nitriding reaction rate can be controlled, and therefore a throughput for preparation of a photosemiconductor is improved. Specifically, when a plasma treatment is performed with a gas containing only nitrogen, metal ions among constituent ions of a compound may be reduced to secure stability. When oxygen exists in a plasma gas, a reduction reaction can be suppressed, but if an amount of oxygen exceeds a certain amount, a nitriding reaction may hardly proceed because oxygen has an electronegativity larger than that of nitrogen, and free energy of formation of an oxide is relatively stable as compared to free energy of formation of a nitride, so that an oxidation reaction rate exceeds a nitriding reaction rate, i.e. a reverse reaction is dominant. In contrast, when a gas with oxygen constituting not more than 0.1% of a total pressure is used, the nitriding reaction rate exceeds the reverse reaction rate, i.e. the oxidation reaction rate, so that the nitriding reaction can be made to slowly proceed as a whole, i.e. the nitriding reaction can be properly controlled.

In a fourth aspect, for example, the transition metal may be at least one selected from vanadium, niobium and tantalum in the manufacturing method according to any one of the first to third aspects.

When a photosemiconductor obtained by a manufacturing method according to the fourth aspect provides ions having a maximum valence of a group 5 transition metal, a conduction band in the photosemiconductor is positioned at an upper end of an oxidation-reduction level of water, i.e. at a level slightly lower than a hydrogen generation level, so that an oxidation reaction of water can be made to easily proceed. Specifically, in carrying out water splitting reaction using sunlight by use of one photosemiconductor, it is preferred that a band gap is theoretically not less than about 1.8 eV and not more than about 2.4 eV, and bands are positioned so as to sandwich the oxidation-reduction level of water, and when an oxygen overvoltage of about 0.6 V to 0.7 V, which is necessary in four-electron oxidation of water, is considered, it is more preferred that the conduction band is positioned at a level slightly lower than the hydrogen generation level, and the valence band is positioned at a level higher than an oxygen generation level by 0.6 V to 0.7 V or more. In determination of a band gap in a material, a larger oxygen overvoltage can be secured as the conduction band is positioned closer to the hydrogen generation level. Thus, when the conduction band is positioned at a level slightly lower than the hydrogen generation level, the oxidation reaction of water more easily proceeds.

In a fifth aspect, for example, the photosemiconductor may be a niobium-containing nitride or a niobium-containing oxynitride in the manufacturing method according to the fourth aspect.

The niobium-containing nitride or the niobium-containing oxynitride is capable of utilizing light having a wavelength in a visible light range, and can serve as a visible light-responsive photocatalyst suitable for water splitting in which the conduction band and the valence band are positioned so as to sandwich the oxidation-reduction level of water. Thus, with a photosemiconductor obtained by the manufacturing method according to the fifth aspect, incident light energy can be effectively utilized for water splitting reaction when sunlight or the like is used as a light source.

In a sixth aspect, for example, the plasma may have a rotation temperature of 480 K to 1100 K in the manufacturing method according to any one of the first to fifth aspects.

First, the “rotation temperature” will now be described. The “rotation temperature” is an index showing a magnitude of rotational energy in a degree of freedom of a molecule around a center of gravity of an atomic nucleus. The rotation temperature is in equilibrium with a translation temperature, i.e. a kinetic temperature due to collision with neutral molecules and exited molecules in a pressure range near atmospheric pressure. Thus, the rotation temperature of a N₂ molecule can be generally considered as a gas temperature. Thus, the gas temperature can be determined by analyzing light emission of a nitrogen plasma, and measuring the rotation temperature. Specifically, the rotation temperature of the N₂ molecule can be calculated by, for example, analyzing a light emission spectrum generated in electron transition from a C³Πᵤ level to B³Π_{g} level, the light emission spectrum being called a 2nd positive system that is one light emission spectrum belonging to a light emission spectrum group of the N₂ molecule. The electron transition is caused by transition from a rotational level in various vibrational levels within a certain electron level to a rotational level or a vibrational level in other electron level. Assuming that electrons existing at the rotational level in the C³Πᵤ level and the B³Π_{g} level are Boltzmann-distributed, a light emission spectrum in a certain vibrational level depends on the rotation temperature. Accordingly, the rotation temperature of the N₂ molecule can be determined by comparing a measured spectrum with a calculated spectrum calculated from a theoretical value. The rotation temperature can be determined by, for example, measuring a light emission spectrum (0,2) band of N₂ which is observed near a wavelength of 380.4 nm, The (0,2) band is a vibrational band in electron transition, and indicates that a vibrational quantum number at the C³Πᵤ level being an upper level is 0, and the vibrational quantum number at the B³Π_{g} level being a lower level is 2. Specifically, a distribution of light emission intensities in a certain vibrational band depends on the rotation temperature. For example, a relative intensity on a shorter wavelength side from a wavelength of 380.4 nm increases as the rotation temperature rises.

In a manufacturing method according to the sixth aspect, a chemical reaction rate at which an oxide as a starting material is nitrided can be controlled by setting the rotation temperature of a plasma to 480 K to 1100 K. Specifically, the chemical reaction rate depends on a reaction rate constant, and the reaction rate constant k is a function dependent on a temperature in accordance with Arrhenius' equation k=Aexp (−Eₐ/RT) (A: frequency factor, Eₐ: activation energy, R: gas constant, temperature: T). Thus, by controlling the temperature, a thickness of the resulting nitride or oxynitride can be controlled.

In a seventh aspect, for example, surfaces of the first and second electrodes may be formed of stainless steel in the manufacturing method according to any one of the first to sixth aspects.

In a manufacturing method according to the seventh aspect, an electrode holding a base material (hereinafter, referred to as a “holding electrode”) in a plasma generating apparatus to be used in a treatment with a plasma is formed of SUS being a material that hardly captures oxygen. Accordingly, oxygen is hardly captured by the holding electrode, and further, deviation of a plasma composition distribution due to release of captured oxygen hardly occurs. Accordingly, stability of a treatment with a plasma is improved, and as a result, stability of manufacturing of a photosemiconductor is improved.

In an eighth aspect, for example, the surfaces of the first and second electrodes may be formed of metal in the manufacturing method according to any one of the first to seventh aspects.

In the manufacturing method of the present disclosure, there is a wide selection of electrode materials because ammonia is not used. As a result, an electrode formed of metal can be used for a long period of time.

A photosemiconductor according to a ninth aspect of the present disclosure includes:

a substrate; and

a photosemiconductor layer,

wherein

the photosemiconductor layer is formed on a front surface of the substrate,

the photosemiconductor layer contains nitrogen, oxygen, and at least one kind of transition metal, and

a ratio of oxygen to nitrogen is smaller on the front surface of the photosemiconductor layer than on a back surface of the photosemiconductor layer.

In the photosemiconductor according to the ninth aspect, the surface of the photosemiconductor layer is a main surface (second main surface) on a side opposite to a main surface (first main surface) situated closer to a base material, among two main surfaces of the photosemiconductor layer. Thus, when the photosemiconductor according to the ninth aspect has a configuration in which other layer is not provided on the photosemiconductor layer, an exposed surface of the photosemiconductor layer corresponds to the “surface of the photosemiconductor layer”, and when the photosemiconductor according to the ninth aspect has a configuration in which some other layer is provided on the photosemiconductor layer, an interface between the photosemiconductor layer and the other layer corresponds to the “surface of the photosemiconductor layer”. In the photosemiconductor layer in the photosemiconductor according to the ninth aspect, a region on a base material side with respect to a center plane of the photosemiconductor layer in a thickness direction is defined as a “base material side of the photosemiconductor layer”, and a region opposite to the “base material side of the photosemiconductor layer” is defined as a “surface side of the photosemiconductor”.

In the photosemiconductor according to the ninth aspect, the photosemiconductor layer contains compounds having mutually different ratios of oxygen to nitrogen on the surface side and on the base material side. In other words, the photosemiconductor layer can be considered as being formed of mutually different semiconductor materials on the surface side and on the base material side, and the photosemiconductor layer itself can serve as a layer which easily separates charges. Thus, electrons and holes generated in the photosemiconductor layer by photoirradiation are hardly recombined in the photosemiconductor layer, and easily move to positions at which reactions involving these electrons and holes take place, respectively. Thus, the photosemiconductor according to the ninth aspect can exhibit excellent charge separation property.

A hydrogen production device according to a tenth aspect of the present disclosure includes:

a photosemiconductor according to the ninth aspect, the photosemiconductor being a visible light-responsive photocatalyst;

an electrolyte; and

a housing containing the photosemiconductor and the electrolyte.

In the hydrogen production device according to the tenth aspect, the photosemiconductor according to the ninth aspect is used as a photocatalyst, and thus hydrogen generation efficiency in water splitting reaction can be improved.

### EXEMPLARY EMBODIMENTS

### First Exemplary Embodiment

Hereinafter, a method for manufacturing a photosemiconductor according to one exemplary embodiment of the present disclosure will be described with reference to drawings. In the drawings, respective constituent elements are schematically shown for easy understanding, and shapes etc, are not correctly depicted. Values, materials, constituent elements, positions of constituent elements, and so on, which are shown in the following exemplary embodiment, are illustrative, and are not intended to limit the method for manufacturing a photosemiconductor according to the present disclosure. Among constituent elements in the following exemplary embodiment, constituent elements which are not described in the manufacturing method according to the first aspect which is a highest-order concept of the present disclosure will be described as optional constituent elements that form a more preferred configuration.

The method for manufacturing a photosemiconductor according to this exemplary embodiment includes treating an oxide containing at least one transition metal with a plasma under a pressure lower than atmospheric pressure to provide the photosemiconductor containing the transition metal and a nitrogen element from the oxide,

wherein

the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

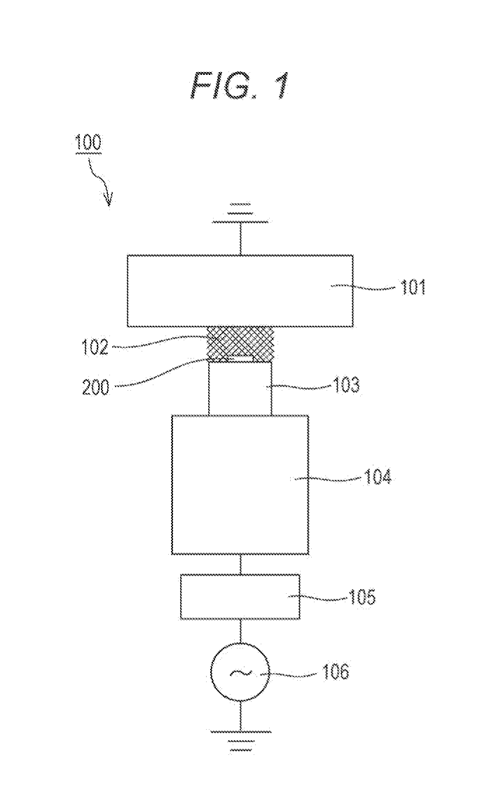

First, one example of a plasma generating apparatus usable in a plasma treatment in the manufacturing method according to this exemplary embodiment will be described with reference to FIG. 1.

FIG. 1 is a schematic view showing an example of a configuration of the plasma generating apparatus. Plasma generating apparatus 100 includes upper electrode 101 connected to ground; lower electrode (holding electrode) 103 also serving as a stage on which a plasma treatment object is set; heater 104 installed below lower electrode 103; matching unit 105 installed below the heater; and high-frequency power source 106. In FIG. 1, reference numeral 102 denotes a plasma. FIG. 1 shows a state in which as a plasma treatment object, photosemiconductor 200 (a laminate including a base material, and an oxide as a starting material formed on the base material) before plasma treatment is set on apparatus 100.

A kind of the plasma is not particularly limited, but use of a non-thermal equilibrium plasma generated by glow discharge is preferred. A thermal equilibrium plasma generated by arc discharge, or the like may also be used.

For generation of the plasma, various kinds of methods and means such as, for example, an inductively coupled plasma method, a microwave plasma method, and electrode methods such as those of parallel-plate type and coaxial type can be used.

As a power source for generating a plasma, a high-frequency power source in a VHF range is used. By using a plasma in a VHF range, a high plasma density can be achieved, so that a chemical reaction rate can be increased, i.e. a chemical reaction can be accelerated. Thus, a VHF power source is used as high-frequency power source 106 in plasma generating apparatus 100 shown in FIG. 1.

High-frequency power source 106 may be installed on an upper electrode 101 side rather than being installed below heater 104 as in plasma generating apparatus 100 shown in FIG. 1.

For upper electrode 101 and lower electrode 103, various metals such as niobium (Nb), tantalum (Ta), aluminum (Al), titanium (Ti), silver (Ag), copper (Cu), silicon (Si), gold (Au), platinum (Pt) and SUS can be used. Since upper electrode 101 and lower electrode 103 are exposed to a plasma, it is preferred that a metal having low corrosiveness, i.e. low reactivity is used for these electrodes. Accordingly, a gas is selectively consumed in upper electrode 101 and lower electrode 103, i.e. a reaction of the gas with the electrode can be prevented from proceeding. The consumed gas component can be prevented from being secondarily volatilized and generated from upper electrode 101 and lower electrode 103 in the treatment. Accordingly, stability of the treatment can be secured without causing deviation of a plasma composition distribution.

For suppressing occurrence of deviation of a plasma composition distribution to improve stability of the plasma treatment, it is preferred that a material which hardly captures oxygen is used for lower electrode 103 that holds a plasma treatment object. The material which hardly captures oxygen is, for example, SUS. Accordingly, oxygen is hardly captured by lower electrode 103, and further, deviation of a plasma composition distribution due to release of captured oxygen hardly occurs, so that stability of a treatment with a plasma is improved, and as a result, stability of manufacturing of a photosemiconductor is improved.

A material (e.g. Nb) which easily captures oxygen may be used for lower electrode 103. When such a material is used, the electrode captures a part of oxygen in a gas to reduce an oxygen partial pressure of the gas even if the oxygen partial pressure of the gas used in the plasma treatment is somewhat high. Therefore, it is not necessary to perform control under a condition for limiting the oxygen partial pressure in the gas to a very low level, and it becomes easy to manufacture a photosemiconductor.

A film which is provided on a surface of a conventional member by, for example, a plasma etching apparatus and which has high plasma resistance and corrosion resistance may be formed on each of upper electrode 101 and lower electrode 103. As materials of the film, yttrium oxide (Y₂O₃), aluminum oxide (Al₂O₃) and the like are known. These films have an effect of suppressing generation of a reaction product due to influences of oxidation and nitriding of electrode members, and an effect of preventing damage to the members by the plasma. Accordingly, a stable plasma treatment can be performed.

One example of a method for manufacturing a photosemiconductor by use of the above-mentioned plasma generating apparatus will now be described.

The photosemiconductor manufactured in this exemplary embodiment is a photosemiconductor which includes a compound containing nitrogen and at least one kind of transition metal in a crystal structure. The transition metal contained in the compound is, for example, niobium. Here, as one example, a method for manufacturing a niobium oxynitride as a photosemiconductor by use of a niobium oxide as a starting material will be described. When the niobium oxynitride has a composition of NbₓO_{y}N_{z}, it is preferred that the niobium oxynitride manufactured in this exemplary embodiment ideally satisfies a relationship of x=y=z=1, i.e. x:y:z=1:1:1.

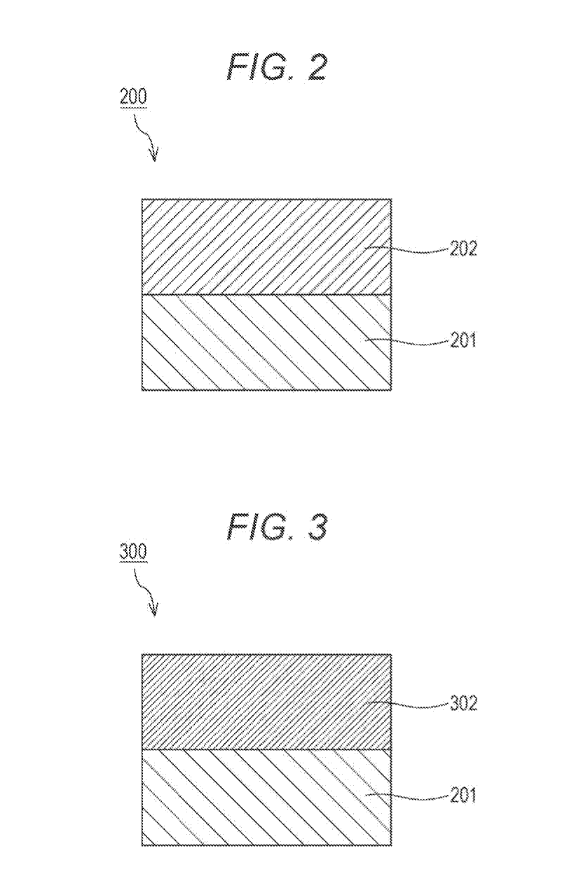

FIGS. 2 and 3 are sectional views showing examples of steps in the method for manufacturing a photosemiconductor according to this exemplary embodiment. Specifically, FIG. 2 is a sectional view showing a starting material layer before plasma treatment, where a niobium oxynitride layer as a starting material layer is formed on a base material. FIG. 3 is a sectional view showing a photosemiconductor after plasma treatment.

First, starting material layer 202 is formed on base material 201 as shown in FIG. 2. Accordingly, photosemiconductor 200 (a laminate including base material 201, and starting material layer 202 formed on base material 201) before plasma treatment is obtained. For base material 201, for example, a c-sapphire substrate can be used. When the photosemiconductor manufactured by the manufacturing method according to this exemplary embodiment is used as an electrode for a device, base material 201 is required to have electrical conductivity. Thus, here, a base material formed of a material having electrical conductivity or a base material with an electrically conductive layer provided on a surface of the base material can be used as base material 201. The base material formed of a material having electrical conductivity is, for example, a metal substrate or an electrically conductive Nb—TiO₂(101) single-crystal substrate. The base material with an electrically conductive layer provided on a surface of the base material is, for example, a base material with an electrically conductive film provided on a surface of an insulating base material such as a glass base material. The electrically conductive film may be a transparent electrically conductive film such as that of ITO (indium-tin oxide) or FTO (fluorine-doped tin oxide). As for a shape of the base material, the base material is not limited to a plate-shaped body (substrate), and may be a three-dimensional structure (three-dimensional structure base material). Whether or not the base material and the electrically conductive film are made to have light permeability may be appropriately determined according to, for example, a configuration of a device to which the photosemiconductor of this exemplary embodiment is applied. As starting material layer 202, for example, a niobium oxide (Nb₂O₅) is formed in a thickness of, for example, 100 nm on base material 201.

Starting material layer 202 is formed by use of, for example, a reactive sputtering method. As a sputtering target, for example, Nb₂O₅ can be used. For example, conditions for formation of Nb₂O₅ as starting material layer 202 are preferably as follows: a target-substrate distance is 10 mm, and a base material temperature is 700° C., sputtering is performed in a mixed atmosphere of argon and oxygen, a total pressure in a chamber is 1.0 Pa, an argon partial pressure is 0.91 Pa, and an oxygen partial pressure is 0.09 Pa. As a method for deposition of starting material layer 202, a method other than a reactive sputtering method can also be used. For example, starting material layer 202 may be formed by a gas phase method such as a molecular beam epitaxy method, a pulse laser deposition method or an organic metal gas phase growth method, or formed by a liquid phase method such as a sol-gel method. Since an oxide as a starting material can be relatively easily formed, a method other than the above-mentioned methods may be used.

Next, as shown in FIG. 3, starting material layer 202 is subjected to a plasma treatment, and an excited nitrogen plasma gas nitrides whole starting material layer 202 to form photosemiconductor layer 302. Accordingly, photosemiconductor 300 after plasma treatment is obtained.

The plasma treatment in the manufacturing method according to this exemplary embodiment is a treatment with a high-frequency plasma in a VHF range as described above. The high-frequency plasma in a VHF range is a plasma generated at a frequency in a range of 30 MHz to 300 MHz.

For example, plasma treatment conditions may be as follows: a temperature of lower electrode 103 (see FIG. 1) is 358° C., a gaseous mixture of nitrogen and oxygen is used, a total pressure is 5 kPa in plasma ignition and 8 kPa in plasma process, an oxygen partial pressure is not more than 0.1% of the total pressure, i.e. not more than 8.0 Pa, a power is 400 W, a gap width between electrodes is 8 mm, and a treatment time is 30 minutes. Here, a rotation temperature of the gas may be 608 K, i.e. 335° C.

The rotation temperature of the plasma gas in performing the plasma treatment is not limited to the above-mentioned temperature, and can be appropriately selected from a range of 480 K to 1100 K, i.e. 207° C. to 827° C.

For example, when the gap width between electrodes is 8 mm, the rotation temperature of the plasma gas is controlled by a pressure, and the pressure may be 5 kPa to 15 kPa. When the pressure is less than 5 kPa, the reaction for nitriding the niobium oxide in starting material layer 202 may be insufficient. When the pressure is more than 15 kPa, the niobium oxide in starting material layer 202 may be reduced, leading to formation of a trivalent niobium oxynitride.

For example, when the pressure is 8 kPa, the rotation temperature of the plasma gas is controlled by a gap width between electrodes in a plasma generating apparatus, and the gap width may be 5.3 mm to 11 mm. When the gap width between electrodes is less than 5.3 mm, the reaction for nitriding the niobium oxide in starting material layer 202 may be insufficient. When the gap width between electrodes is more than 11 mm, the niobium oxide in starting material layer 202 may be reduced, leading to formation of a trivalent niobium oxynitride.

For example, when the pressure is 10 kPa, the rotation temperature of the plasma gas is controlled by an electric power per area of the plasma generating apparatus, and the electric power per area may be 88 W/cm² to 808 W/cm². When the electric power per area is less than 400 W/cm², the reaction for nitriding the niobium oxide in starting material layer 202 may be insufficient. When the electric power per area is more than 800 W/cm², the niobium oxide in starting material layer 202 may be reduced, leading to formation of a trivalent niobium oxynitride.

A temperature is not required to be applied to lower electrode 103 (see FIG. 1). The temperature on the lower electrode 103 side is expected to have an effect of enhancing diffusion of nitrogen, and a sufficient nitriding ability is exhibited only with a plasma gas temperature. Here, a nitriding treatment can be performed without applying a temperature to lower electrode 103, and apparatus 100 can be simplified.

With regard to the plasma gas, the nitriding ability varies according to, for example, a partial pressure ratio of nitrogen and oxygen, and a relationship between plasma treatment conditions and a nitriding degree is not limited to the relationship described above. A range of each of preferred plasma treatment conditions can be appropriately selected according to, for example, a partial pressure ratio of nitrogen and oxygen in the plasma gas. The nitriding ability also varies depending on magnitudes of the electrode area, the power and so on, and therefore the electrode area, the power and so on are not limited to the conditions described above.

Preferably, the plasma treatment is performed by use of a gas containing nitrogen and having an oxygen partial pressure of not more than 0.1 of the total pressure.

The plasma gas is any one of

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

The electric power per area in plasma treatment may be, for example, 88 W/cm² to 808 W/cm².

With the manufacturing method of this exemplary embodiment, a photosemiconductor can be manufactured in which a photosemiconductor layer including a compound containing nitrogen and at least one kind of transition metal (e.g. niobium) in a crystal structure is provided on a base material. With the manufacturing method of this exemplary embodiment, for example, a photosemiconductor layer can be manufactured in which a ratio of oxygen to nitrogen in the crystal structure of the compound is larger on a base material side of the photosemiconductor layer than a surface side of the photosemiconductor layer. Such a photosemiconductor layer itself can serve as a layer which easily separates charges, and therefore electrons and holes generated in the photosemiconductor layer by, for example, photoirradiation are hardly recombined. Thus, a photosemiconductor provided with such a photosemiconductor layer can exhibit excellent charge separation property. With the manufacturing method of this exemplary embodiment, for example, a photosemiconductor layer can also be prepared which has a configuration in which the ratio of oxygen to nitrogen in the crystal structure of the compound continuously increases from a surface of the photosemiconductor layer toward the base material side. With a photosemiconductor layer having a configuration in which the ratio of oxygen to nitrogen in the crystal structure continuously increases as described above, a photosemiconductor having improved charge separation property can be provided.

### Second Exemplary Embodiment

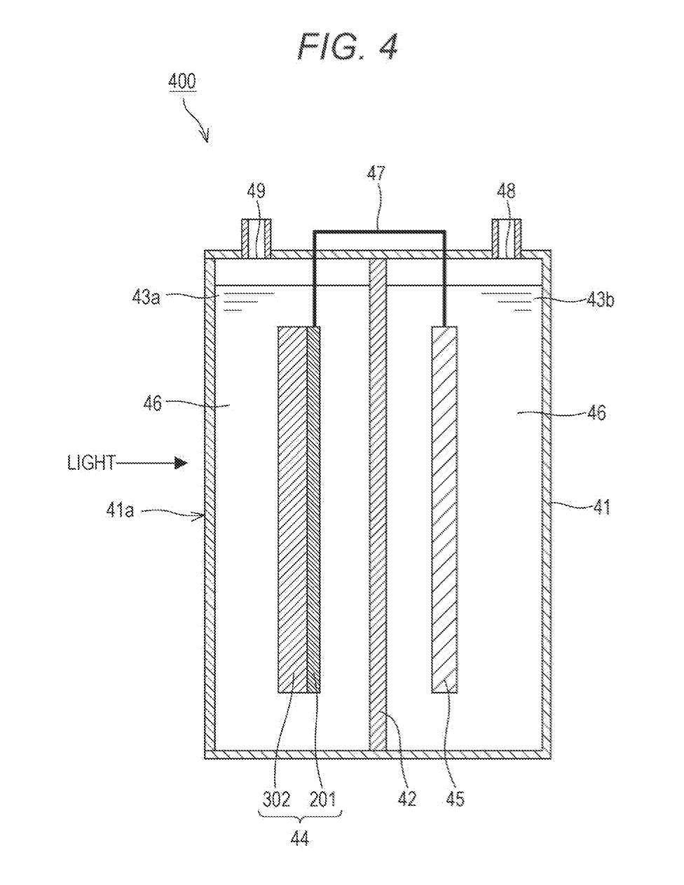

A hydrogen production device according to a second exemplary embodiment of the present disclosure will be described with reference to FIG. 4. FIG. 4 is a schematic view showing one example of a configuration of a hydrogen production device according to this exemplary embodiment.

Hydrogen production device 400 shown in FIG. 4 includes: housing 41; separator 42 which separates an internal space of housing 41 into first space 43a and second space 43b; water splitting electrode 44 disposed in first space 43a; counter electrode 45 disposed in second space 43b; and electrolyte solution 46 containing water in first space 43a and second space 43b. Water splitting electrode 44 and counter electrode 45 are electrically connected to each other by electrical connector 47. Hydrogen production device 400 is further provided with hydrogen gas outlet 48 extending through housing 41 and communicating with an inner part of one of first space 43a and second space 43b that is on a hydrogen generation side (inner part of second space 43b in an example shown in FIG. 4). As necessary, hydrogen production device 400 may be provided with oxygen gas outlet 49 extending through housing 41 and communicating with an inner part of one of first space 43a and second space 43b that is on an oxygen generation side (inner part of first space 43a in an example shown in FIG. 4).

Components of hydrogen production device 400 will now be described in detail.

Housing 41 has light-transmitting surface 41a facing first space 43a. Light-transmitting surface 41a is a surface (photoirradiation surface) of housing 41 which is irradiated with light. Preferably, light-transmitting surface 41a is formed of a material which has corrosion resistance and insulation quality to electrolyte solution 46 and which is permeable to light in a visible light range. More preferably, light-transmitting surface 41a is formed of a material which is permeable to not only light having a wavelength in a visible light range but also light having a wavelength around the visible light range. Examples of the material include glass and resin. A part of housing 41 other than light-transmitting surface 41a is only required to have corrosion resistance and insulation quality to electrolyte solution 46, and is not required to have light permeability. For the part of housing 41 other than light-transmitting surface 41a, not only the glass and resin but also metal with a surface subjected to processing for imparting corrosion resistance and insulation can be used.

As described above, separator 42 separates the inner part of housing 41 into first space 43a containing water splitting electrode 44 and second space 43b containing counter electrode 45. Preferably, separator 42 is disposed so as to be substantially parallel to light-transmitting surface 41a being a photoirradiation surface of housing 41 as shown in, for example, FIG. 4. Separator 42 plays a role of exchanging ions between electrolyte solution 46 in first space 43a and electrolyte solution 46 in second space 43b. Accordingly, at least a part of separator 42 is in contact with electrolyte solution 46 in first space 43a and in second space 43b. Separator 42 is formed of a material which is permeable to an electrolyte in electrolyte solution 46 and which serves to suppress permeation of an oxygen gas and a hydrogen gas in electrolyte solution 46. A material of separator 42 is, for example, a solid electrolyte such as a high-molecular solid electrolyte. Examples of the high-molecular solid electrolyte include ion exchange membranes such as Nafion (registered trademark). Since the space on the oxygen generation side and the space on the hydrogen generation side in the housing are separated by separator 42, generated oxygen and hydrogen can be collected separately from each other.

Water splitting electrode 44 is photosemiconductor 300 (see FIG. 3) obtained by the manufacturing method described in the first exemplary embodiment. Thus, water splitting electrode 44 includes base material 201, and photosemiconductor layer 302 disposed on base material 201. In this exemplary embodiment, photosemiconductor 300 is used as an electrode for a device, base material 201 has electrical conductivity as described in the first exemplary embodiment. In an example shown in FIG. 4, water splitting electrode 44 is disposed in such a direction that a surface of photosemiconductor layer 302 faces light-transmitting surface 41a of housing 41, i.e. photosemiconductor layer 302 forms a light-receiving surface. However, water splitting electrode 44 may be disposed in a direction opposite to the above-mentioned direction. Thus, water splitting electrode 44 may be disposed in such a direction that a surface of base material 201 faces light-transmitting surface 41a of housing 41, i.e. base material 201 forms a light-receiving surface. However, when base material 201 forms a light-receiving surface, base material 201 is required to have light permeability.

Photosemiconductor layer 302 provided on base material 201 is not necessarily required to be a single-phase semiconductor, and may be a composite composed of a plurality of semiconductors, or may carry a metal etc. serving as a co-catalyst. A mechanism capable of applying a bias voltage may be provided between photosemiconductor layer 302 and counter electrode 45.

For counter electrode 45, a material active to a hydrogen generation reaction is used when a photosemiconductor having electrical conductivity and forming photosemiconductor layer 302 of water splitting electrode 44 is an n-type semiconductor, and a material active to an oxygen generation reaction is used when the photosemiconductor is a p-type semiconductor. Examples of the material of counter electrode 45 include carbon and noble metals which are generally used in electrodes for electrolysis of water. Specifically, carbon, platinum, platinum-carried carbon, palladium, iridium, ruthenium, nickel and so on can be employed. A shape of counter electrode 45 is not particularly limited, and an installation position of counter electrode 45 is not particularly limited as long as it is installed in second space 43b. Counter electrode 45 and an inner wall of second space 43b may be in contact with each other, or at a distance from each other.

For electrical connector 47, for example, a general metallic conducting wire can be used.

Electrolyte solution 46 contained in first space 43a and second space 43b may be an electrolyte solution which contains water and in which an electrolyte is dissolved, and electrolyte solution 46 may be acidic, neutral or basic. Examples of the electrolyte include hydrochloric acid, sulfuric acid, nitric acid, potassium chloride, sodium chloride, potassium sulfate, sodium sulfate, sodium hydrogen carbonate, sodium hydroxide, phosphoric acid, sodium dihydrogen phosphate, disodium hydrogen phosphate and sodium phosphate. Electrolyte solution 46 may contain a plurality of the electrolytes.

Operations of hydrogen production device 400 will now be described where the photosemiconductor contained in photosemiconductor layer 302 is an n-type semiconductor, i.e. oxygen is generated from water splitting electrode 44.

In hydrogen production device 400, light passing through light-transmitting surface 41a of housing 41 and electrolyte solution 46 in first space 43a is incident to photosemiconductor layer 302 of water splitting electrode 44, Photosemiconductor layer 302 absorbs light to cause photo-excitation of electrons, so that in photosemiconductor layer 302, electrons are generated in a conduction band, and holes are generated in a valence band. Holes generated by photoirradiation move to a surface of photosemiconductor layer 302 (interface with electrolyte solution 46). The holes oxidize water molecules at the surface of photosemiconductor layer 302, resulting in generation of oxygen (reaction formula (D) described below). Electrons generated in the conduction band move to base material 201, and move an electrically conductive part of base material 201 to counter electrode 45 through electrical connector 47. The electrons move through an inner part of counter electrode 45 to arrive at a surface of counter electrode 45 (interface with electrolyte solution 46), and reduce protons at the surface of counter electrode 45, resulting in generation of hydrogen (reaction formula (E) described below).

4h⁺+2H₂O→O₂↑+4H⁺ (D) 4e⁻+4H⁺→2H₂↑ (E)

The hydrogen gas generated in second space 43b is collected through hydrogen gas outlet 48 communicating with the inner part of second space 43b.

Hydrogen production device 400 of this exemplary embodiment has been described by showing as an example a case where the photosemiconductor forming photosemiconductor layer 302 is an n-type semiconductor, and when the photosemiconductor forming photosemiconductor layer 302 is a p-type semiconductor, operations of hydrogen production device 400 may be described with oxygen and hydrogen replaced by each other in the foregoing operations where the photosemiconductor is formed of an n-type semiconductor.

While the exemplary embodiments of the present disclosure have been described above, the present disclosure is not limited to the exemplary embodiments, and can be refined, changed or modified without departing from a spirit of the present disclosure.

### EXAMPLES

The present disclosure will be described further in detail by way of examples. The following examples are illustrative, and the present disclosure is not limited by the following examples.

### Example 1

A c-sapphire substrate was used as base material 201. As starting material layer 202, a niobium oxide (Nb₂O₅) was deposited in a thickness of 100 nm on the base material. The deposition of the niobium oxynitride was performed by reactive sputtering. As a sputtering target, Nb₂O₅ was used. The niobium oxide was deposited under the following conditions: a target-substrate distance was 10 mm, a substrate temperature was 700° C., sputtering was performed in a mixed atmosphere of argon and oxygen, and a total pressure in a chamber was 1.0 Pa (argon partial pressure: 0.91 Pa, oxygen partial pressure: 0.09 Pa).

Next, the niobium oxynitride was subjected to a plasma treatment by use of plasma apparatus 100 shown in FIG. 1. In this example, an electrode formed of Nb was used as lower electrode 103 in plasma apparatus 100. Plasma treatment conditions were as follows: a temperature of lower electrode 103 was 388° C., a total pressure was 5 kPa in plasma ignition and 8 kPa in plasma process, an oxygen partial pressure was 0% of the total pressure, a power was 400 W, a gap width between electrodes was 10.0 mm, and a treatment time was 30 minutes. Here, a rotation temperature of the gas was 608 K, i.e. 335° C. The oxygen partial pressure being 0% of the total pressure means that a gas which does not contain oxygen, and consists of a nitrogen gas was used in the plasma treatment. The plasma treatment performed in this example was a treatment with a plasma generated at a frequency in a VHF range, and the frequency was 100 MHz. By the plasma treatment, photosemiconductor layer 302 was formed on base material 201.

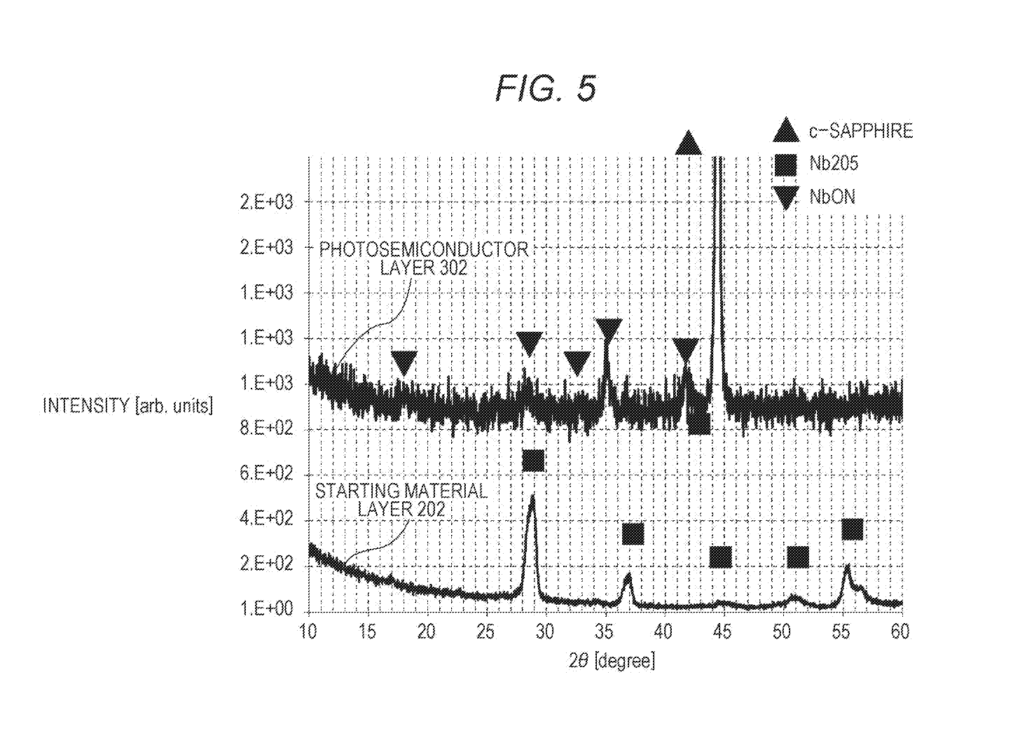

FIG. 5 shows results of X-ray diffraction measurement for starting material layer 202 and photosemiconductor layer 302 obtained in this example. In the measurement results for starting material layer 202, only peaks arising from the niobium oxide are observed, while in the measurement results for the photosemiconductor layer 302, only peaks arising from a niobium oxynitride (NbON) are observed except for a peak arising from the c-sapphire substrate. These results show that it was able to synthesize the niobium oxynitride (NbON) in this example.

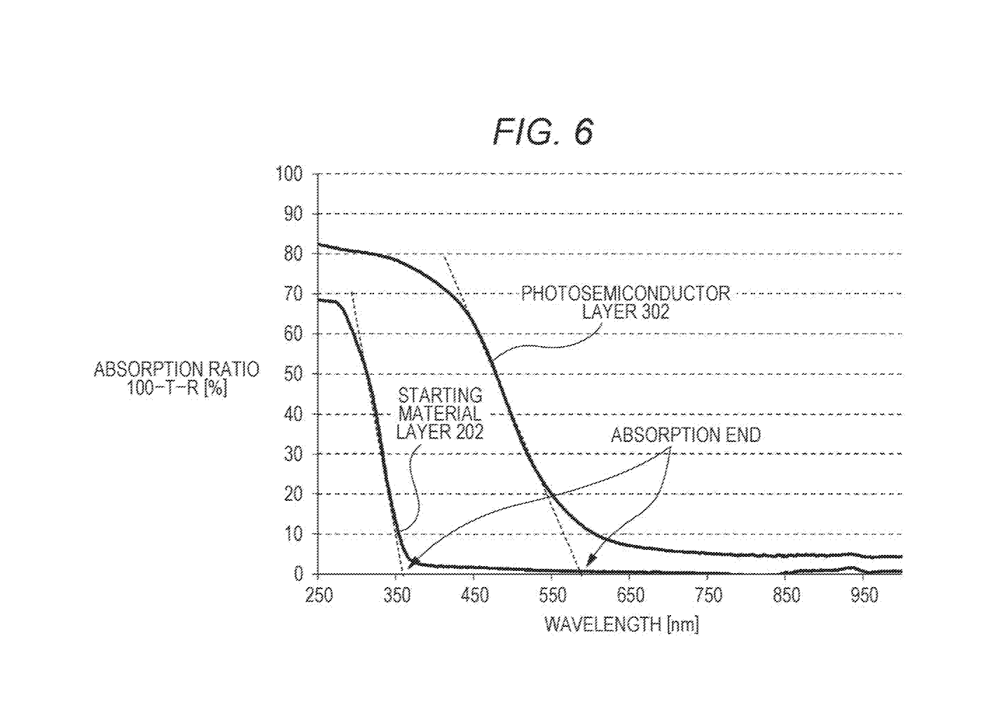

FIG. 6 shows results of visible ultraviolet absorption spectroscopy for starting material layer 202 and photosemiconductor layer 302 obtained in this example. In starting material layer 202, an absorption end arising from the niobium oxide is observed near a wavelength of 350 nm, while in photosemiconductor layer 302, an absorption end is observed near a wavelength of 600 nm. The results of visible ultraviolet absorption spectroscopy show that it was able to synthesize the niobium oxynitride (NbON) in this example. In connection with these results, it was able to visually observe a change in color of thin films of starting material layer 202 and photosemiconductor layer 302. Specifically, it was able to observe a transparent color in photosemiconductor 200 before plasma treatment, which is provided with starting material layer 202, while it was able to observe orange color in photosemiconductor 300 after plasma treatment, which is provided with photosemiconductor layer 302. This is because NbON had a band gap of 2.1 eV and absorbed light (color of light: violet, blue and green) having a wavelength shorter than a wavelength of 600 nm at an optical absorption end, and it was able to observe complementary colors for the colors of the absorbed light. Thus, the visual observation also demonstrated that it was able to synthesize the niobium oxynitride (NbON).

### Example 2

Photosemiconductor layer 302 was formed on base material 201 using a method identical to that in Example 1 except that plasma treatment conditions were changed. In the plasma treatment in this example, plasma apparatus 100 identical to that in Example 1 was used. Plasma treatment conditions were as follows: a temperature of lower electrode 103 was 430° C., a total pressure was 5 kPa in plasma ignition and 8 kPa in plasma process, an oxygen partial pressure was 0.025% of the total pressure, i.e. 2.0 Pa, a power was 300 W, a gap width between electrodes was 4.5 mm, and a treatment time was 30 minutes. The plasma treatment performed in this example was a treatment with a plasma generated at a frequency in a VHF range, and the frequency was 100 MHz. By the plasma treatment, photosemiconductor layer 302 was formed on base material 201.

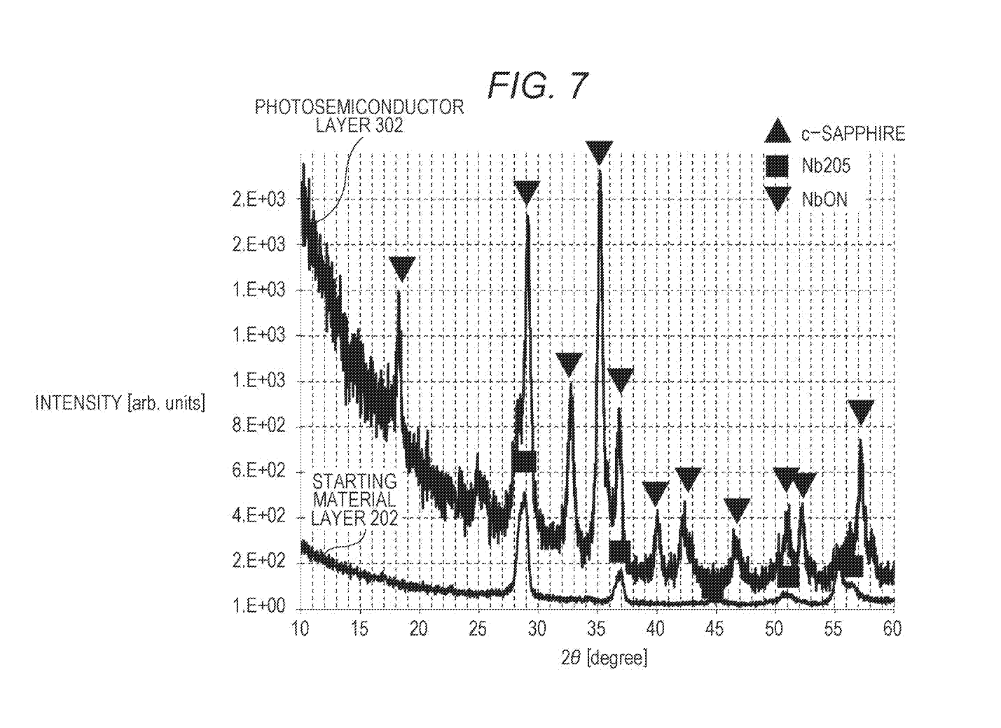

FIG. 7 shows results of X-ray diffraction measurement for starting material layer 202 and photosemiconductor layer 302 obtained in this example. In the measurement results for starting material layer 202, only peaks arising from the niobium oxide are observed, while in the measurement results for the photosemiconductor layer 302, only peaks arising from a niobium oxynitride (NbON) are observed except for a peak arising from the c-sapphire substrate. These results show that it was able to synthesize the niobium oxynitride (NbON) in this example.

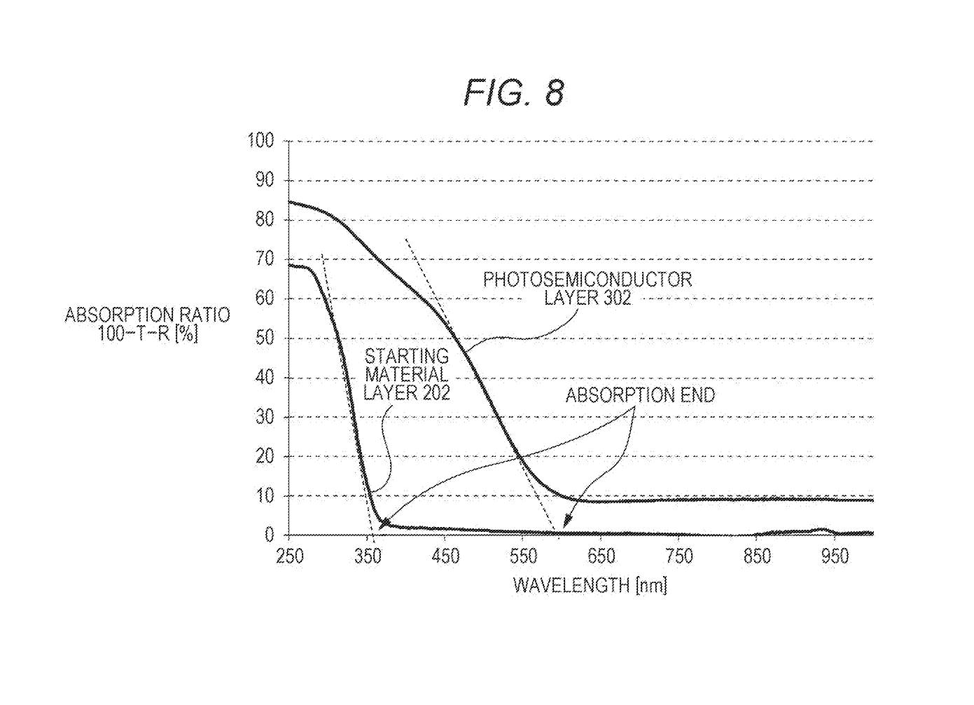

FIG. 8 shows results of visible ultraviolet absorption spectroscopy for starting material layer 202 and photosemiconductor layer 302 obtained in this example. In starting material layer 202, an absorption end arising from the niobium oxide is observed near a wavelength of 350 nm, while in photosemiconductor layer 302, an absorption end is observed near a wavelength of 600 nm. The results of visible ultraviolet absorption spectroscopy show that it was able to synthesize the niobium oxynitride (NbON) in this example. In connection with these results, it was able to visually observe a change in color of thin films of starting material layer 202 and photosemiconductor layer 302. Specifically, it was able to observe a transparent color in photosemiconductor 200 before plasma treatment, which is provided with starting material layer 202, while it was able to observe orange color in photosemiconductor 300 after plasma treatment, which is provided with photosemiconductor layer 302. This is because NbON had a band gap of 2.1 eV and absorbed light (color of light: violet, blue and green) having a wavelength shorter than a wavelength of 600 nm at an optical absorption end, and it was able to observe complementary colors for the colors of the absorbed light. Thus, the visual observation also demonstrated that it was able to synthesize the niobium oxynitride (NbON).

### Example 3

Photosemiconductor layer 302 was formed on base material 201 using a method identical to that in Example 1 except that plasma treatment conditions were changed. In the plasma treatment in this example, plasma apparatus 100 identical to that in Example 1 was used. Plasma treatment conditions were as follows: a temperature of lower electrode 103 was 388° C., a total pressure was 5 kPa in plasma ignition and 8 kPa in plasma process, an oxygen partial pressure was 0.0125% of the total pressure, i.e. 2.0 Pa, a power was 400 W, a gap width between electrodes was 9.0 mm, and a treatment time was 30 minutes. Here, a rotation temperature of the gas was 608 K, i.e. 335° C. The plasma treatment performed in this example was a treatment with a plasma generated at a frequency in a VHF range, and the frequency was 100 MHz. By the plasma treatment, photosemiconductor layer 302 was formed on base material 201.

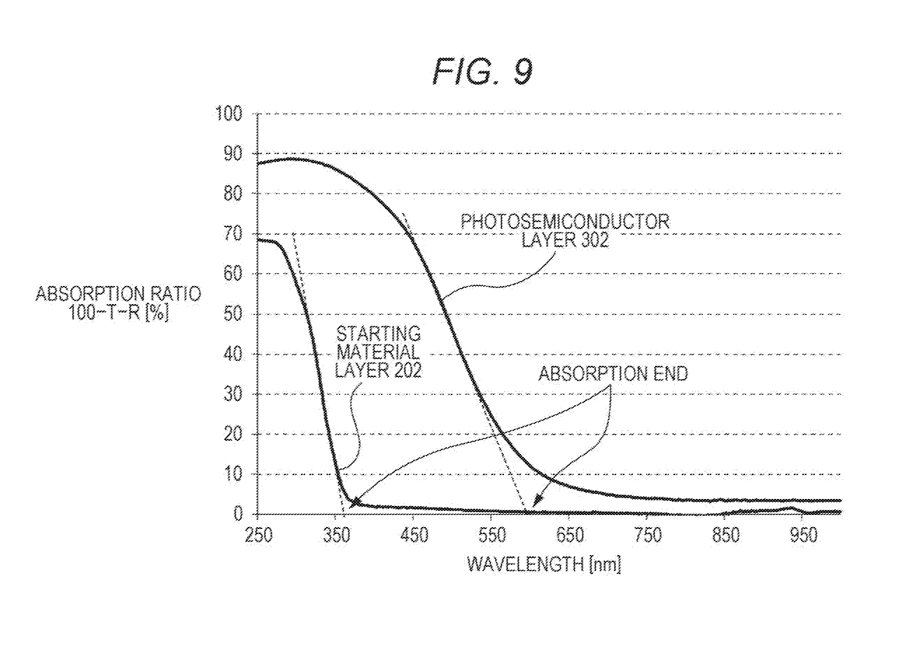

FIG. 9 shows results of visible ultraviolet absorption spectroscopy for starting material layer 202 and photosemiconductor layer 302 obtained in this example. In starting material layer 202, an absorption end arising from the niobium oxide is observed near a wavelength of 350 nm, while in photosemiconductor layer 302, an absorption end is observed near a wavelength of 600 nm. The results of visible ultraviolet absorption spectroscopy show that it was able to synthesize the niobium oxynitride (NbON) in this example. In connection with these results, it was able to visually observe a change in color of thin films of starting material layer 202 and photosemiconductor layer 302. Specifically, it was able to observe a transparent color in photosemiconductor 200 before plasma treatment, which is provided with starting material layer 202, while it was able to observe orange color in photosemiconductor 300 after plasma treatment, which is provided with photosemiconductor layer 302. This is because NbON had a band gap of 2.1 eV and absorbed light (color of light: violet, blue and green) having a wavelength shorter than a wavelength of 600 nm at an optical absorption end, and it was able to observe complementary colors for the colors of the absorbed light. Thus, the visual observation also demonstrated that it was able to synthesize the niobium oxynitride (NbON).

### Example 4

Photosemiconductor layer 302 was formed on base material 201 using a method identical to that in Example 1 except that the material of lower electrode 103 in plasma apparatus 100 and plasma treatment conditions were changed. In this example, an electrode formed of SUS 316 was used as lower electrode 103. Plasma treatment conditions were as follows: a temperature of lower electrode 103 was 388° C., a total pressure was 5 kPa in plasma ignition and 8 kPa in plasma process, an oxygen partial pressure was 0.002% of the total pressure, i.e. 0.16 Pa, a power was 400 W, a gap width between electrodes was 10.5 mm, and a treatment time was 30 minutes. The plasma treatment performed in this example was a treatment with a plasma generated at a frequency in a VHF range, and the frequency was 100 MHz. By the plasma treatment, photosemiconductor layer 302 was formed on base material 201.

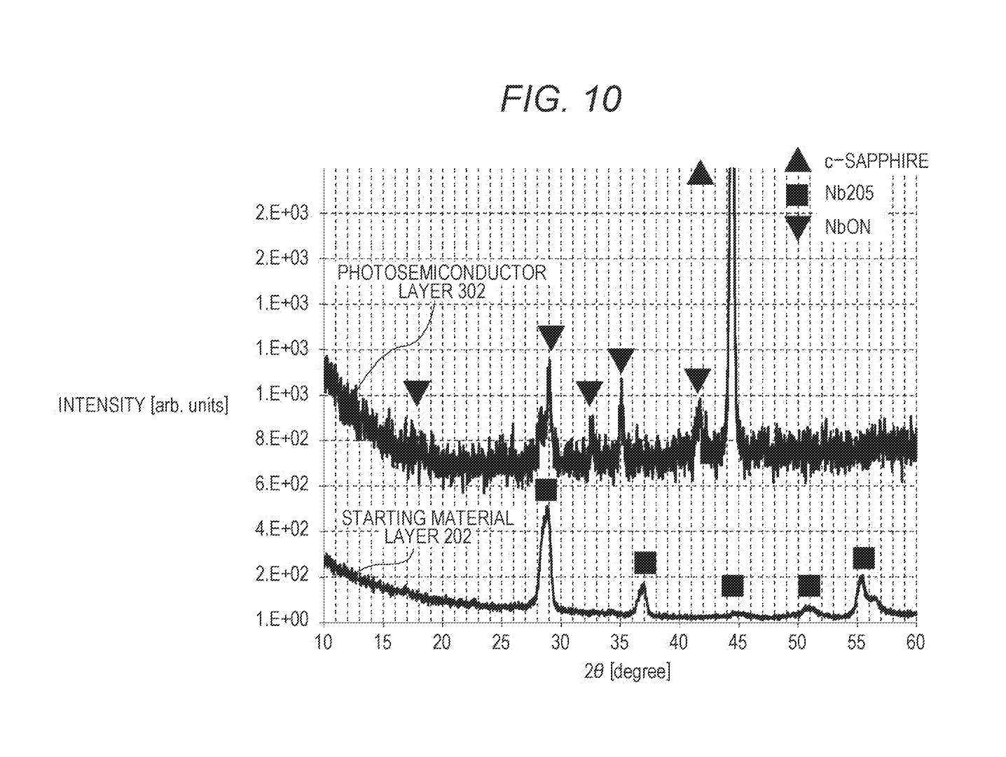

FIG. 10 shows results of X-ray diffraction measurement for starting material layer 202 and photosemiconductor layer 302 obtained in this example. In the measurement results for starting material layer 202, only peaks arising from the niobium oxide are observed, while in the measurement results for the photosemiconductor layer 302, only peaks arising from a niobium oxynitride (NbON) are observed except for a peak arising from the c-sapphire substrate. These results show that it was able to synthesize the niobium oxynitride (NbON) in this example.

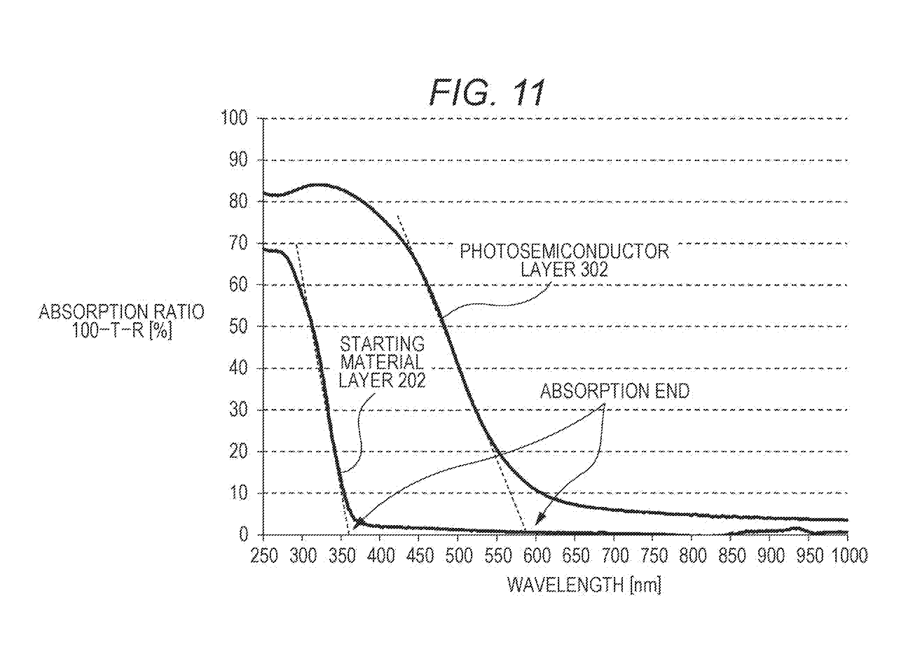

FIG. 11 shows results of visible ultraviolet absorption spectroscopy for starting material layer 202 and photosemiconductor layer 302 obtained in this example. In starting material layer 202, an absorption end arising from the niobium oxide is observed near a wavelength of 350 nm, while in photosemiconductor layer 302, an absorption end is observed near a wavelength of 600 nm. The results of visible ultraviolet absorption spectroscopy show that it was able to synthesize the niobium oxynitride (NbON) in this example. In connection with these results, it was able to visually observe a change in color of thin films of starting material layer 202 and photosemiconductor layer 302. Specifically, it was able to observe a transparent color in photosemiconductor 200 before plasma treatment, which is provided with starting material layer 202, while it was able to observe orange color in photosemiconductor 300 after plasma treatment, which is provided with photosemiconductor layer 302. This is because NbON had a band gap of 2.1 eV and absorbed light (color of light: violet, blue and green) having a wavelength shorter than a wavelength of 600 nm at an optical absorption end, and it was able to observe complementary colors for the colors of the absorbed light. Thus, the visual observation also demonstrated that it was able to synthesize the niobium oxynitride (NbON).

The method for manufacturing a photosemiconductor according to the present disclosure can be used as a method for manufacturing a visible light-responsive photocatalyst, and is useful in, for example, photocatalyst related techniques such as devices for producing hydrogen from sunlight.

### REFERENCE SIGNS LIST

100 plasma apparatus

101 upper electrode

102 plasma

103 lower electrode (holding electrode)

104 heater

105 matching unit

106 high frequency power source

200 photosemiconductor before plasma treatment

201 base material

202 starting material layer

300 photosemiconductor after plasma treatment

302 photosemiconductor layer,

400 hydrogen production device

41 housing

41a light-transmitting surface

42 separator

43a first space

43b second space

44 water splitting electrode

45 counter electrode

46 electrolyte solution

47 electrical connector

48 hydrogen gas outlet

49 oxygen gas outlet

What is claimed is:

1. A method for manufacturing a photosemiconductor, the method comprising treating an oxide containing at least one transition metal with a plasma under a pressure lower than atmospheric pressure to provide the photosemiconductor containing the transition metal and a nitrogen element from the oxide,
wherein
the plasma is generated by applying a high-frequency voltage at a frequency in a range of not less than 30 MHz and not more than 300 MHz to a gas between a first electrode and a second electrode, and
the gas is any one of:
(i) a nitrogen gas;
(ii) a gaseous mixture consisting of a nitrogen gas and an oxygen gas;
(iii) a gaseous mixture consisting of a nitrogen gas and a rare gas; and
(iv) a gaseous mixture consisting of a nitrogen gas, an oxygen gas, and a rare gas.

2. The method according to claim 1, wherein
the photosemiconductor is a visible light-responsive photocatalyst.

3. The method according to claim 1, wherein
the gas is any one of:
(ii) a gaseous mixture of a nitrogen gas and an oxygen gas; and
(iv) a gaseous mixture of a nitrogen gas, an oxygen gas and a rare gas, and
the oxygen gas has a partial pressure of not more than 0.1%.

4. The method according to claim 1, wherein
the transition metal is at least one selected from vanadium, niobium, and tantalum.

5. The method according to claim 4, wherein
the photosemiconductor is a niobium-containing nitride or a niobium-containing oxynitride.

6. The method according to claim 1, wherein
the plasma has a rotation temperature of 480 K to 1100 K.

7. The method according to claim 1, wherein
surfaces of the first and second electrodes are formed of stainless steel.

8. The method according to claim 1, wherein
the surfaces of the first and second electrodes are formed of metal.

9. A photosemiconductor comprising:
a substrate; and
a photosemiconductor layer,
wherein
the photosemiconductor layer is formed on a front surface of the substrate,
the photosemiconductor layer contains nitrogen, oxygen, and at least one kind of transition metal, and
a ratio of oxygen to nitrogen is smaller on a front surface of the photosemiconductor layer than on a back surface of the photosemiconductor layer.

10. A hydrogen production device comprising:
the photosemiconductor according to claim 9, the photosemiconductor being a visible light-responsive photocatalyst;
an electrolyte; and
a housing containing the photosemiconductor and the electrolyte.
